(19) United States
(12) Patent Application Publication
(10) Pub. No.: US 2014/0200328 A1
(43) Pub. Date: Jul. 17, 2014

(54) METHOD FOR PRODUCING ZINC DICARBOXYLATE

(71) Applicants: Anna Katharina Brym, Limburgerhof (DE); Jürgen Zubiller, Kaiserslautern (DE); Gerrit Luinstra, Hamburg (DE); Revaz Korashvili, Hamburg (DE)

(72) Inventors: Anna Katharina Brym, Limburgerhof (DE); Jürgen Zubiller, Kaiserslautern (DE); Gerrit Luinstra, Hamburg (DE); Revaz Korashvili, Hamburg (DE)

(73) Assignee: BASF SE, Ludwigshafen (DE)

(21) Appl. No.: 14/343,604

(22) PCT Filed: Aug. 31, 2012
(86) PCT No.: PCT/EP2012/066930

§ 371 Date: Mar. 7, 2014

(30) Foreign Application Priority Data
Sep. 9, 2011 (EP) 11180727.7

(51) Int. Cl. C08G 64/34; C07F 3/06

(52) U.S. Cl. CPC C08G 64/34; C07F 3/06
USPC 528/405; 556/118

(57) ABSTRACT

The invention relates to a process for preparing a zinc dicarboxylate from a zinc compound and a C₄-C₁₀ dicarboxylic acid in the presence of a cationic emulsifier and a solvent.

The invention also relates to zinc dicarboxylates obtainable by the abovementioned process and having a BET surface area of 50 to 750 m²/g.

The invention relates to a process for preparing a zinc dicarboxylate from a zinc compound and a C₄-C₁₀ dicarboxylic acid in the presence of a cationic emulsifier and a solvent.

The invention also relates to zinc dicarboxylates obtainable by the abovementioned process and having a BET surface area of 50 to 750 m²/g.

The invention further relates to a process for preparing polyalkylene carbonates by polymerizing carbon dioxide with at least one epoxide selected from ethylene oxide, propylene oxide, butene oxide, cyclopentene oxide and cyclohexene oxide in the presence of a zinc salt of a C₄-C₁₀ dicarboxylic acid (zinc dicarboxylate), wherein the zinc dicarboxylate is prepared from a zinc compound and a C₄-C₁₀ dicarboxylic acid in the presence of a cationic emulsifier and a solvent.

Polyalkylene carbonates such as polypropylene carbonates are obtained by alternating copolymerization of carbon dioxide and an alkylene oxide such as propylene oxide. A wide variety of homogeneous and also heterogeneous catalysts are used therefor. The heterogeneous catalysts used are particularly zinc glutarates.

WO 03/029325 describes processes for preparing aliphatic polycarbonates. Zinc dicarboxylates, in particular zinc glutarate or zinc adipate, can be used therein in addition to multimetal cyanide compounds. The preparation of the zinc glutarate catalyst is carried out by reacting ground zinc oxide with glutaric acid in toluene. After the reaction, the water of reaction is removed by azeotropic distillation. The toluene solvent is then removed by distillation and the residue is dried under high vacuum.

For the zinc glutarate catalyst, the level of catalyst activity is dependent on the moisture content of the catalyst. Zinc glutarate in a completely dried state shows very little, if any, catalyst activity. Only through addition of water and/or absorption of atmospheric humidity is the maximum activity reached. Additionally, zinc glutarate catalyst powder has a tendency to clump and can therefore be metered only with difficulty, particularly after prolonged storage.

Jong-Seong Kim et al., in Journal of Polymer Science, Part A, Polymer Chemistry 2005, vol. 43, p. 4079-4088, describe a process for preparing zinc glutarates in the presence of polar solvents and nonionic emulsifiers such as polyethylene-co-propylene glycol. The zinc glutarates thus obtained have a higher activity in polyalkene carbonate synthesis than the zinc glutarates prepared according to WO 03/029325. However, these zinc glutarates are also not entirely satisfactory with regard to their TOF (turnover frequency).

It is an object of the present invention to provide improved polymerization catalysts for preparing polyalkylene carbonates, which avoid the abovementioned disadvantages of prior art zinc glutarate catalysts and which, in particular, show improved activity.

This object is achieved according to the invention by zinc salts of a C₄-C₁₀ dicarboxylic acid (zinc dicarboxylates), said zinc dicarboxylates being prepared from a zinc compound and a C₄-C₁₀ dicarboxylic acid in the presence of a cationic emulsifier and a solvent.

The preparation of the catalysts according to the invention (zinc dicarboxylates) is otherwise carried out analogously or similarly to the processes known from the prior art. Reference may be made, for example, to the process according to WO 03/029325 and in particular to Example 1 on page 22 therein, or else to Journal of Polymer Science, Part A, Polymer Chemistry 2005, vol. 43, p. 4080-4081—Synthesis of catalysts.

As the zinc source, a zinc oxide, zinc nitrate or a zinc acetate is generally used. However, any other soluble zinc salt is equally suitable.

In addition to untreated zinc oxide, surface-modified zinc oxide particles, as described in PCT/EP2011/053259 and WO 06/092442, can be used. Surface-modified zinc oxide particles are described therein which are obtainable by treatment of zinc oxide particles with organosilanes, silazanes and/or polysiloxanes and subsequent heat-treatment and/or UV irradiation of the treated zinc oxide particles.

Typical C₄-C₁₀ dicarboxylic acids are succinic acid, glutaric acid, adipic acid, pimelic acid, suberic acid, azelaic acid (nonanedioic acid) and sebacic acid. Glutaric acid and adipic acid are particularly preferred.

Cationic emulsifiers are generally understood as meaning long-chain amines, preferably primary amines and more preferably primary C₁₀-C₃₀ alkylamines. These can form micelles, particularly in polar solvents. The amines can be used directly or in the form of their salts. It is preferred that the amines be used directly (in free form). At least some of the amine should be used in free form in order to obtain good yields of zinc dicarboxylates.

Following the removal of the surfactant, which is preferably carried out by washing with a liquid or by drying, the active catalysts are isolated. The drying temperature is important in the activation of zinc dicarboxylates. The series of tests set out in Table 4 shows that the activity of the catalyst obtained can be increased by the use of the correct drying temperature. The removal of the hexadecylamine is carried out in vacuo at a temperature of 100° C. to 250° C., preferably 130° C. to 170° C., and a pressure of 0.001 mbar to 50 mbar.

The cationic emulsifier is generally used in an amount-of-substance ratio (in mol %) of 100:1 to 1:100, preferably 10:1 to 1:2 and more preferably 4:1 to 1:1, based on the zinc salt used.

n-Hexadecylamine is particularly preferred. Amines with shorter chains (for example smaller than C₁₀) lead to lower catalyst activities. N-Octadecylamine does likewise give zinc glutarates with very high catalyst activities, but even octadecylamine is more difficult to remove. Even during removal by vacuum distillation, this amine may partially decompose leading to browning of the catalyst.

The zinc dicarboxylates are prepared in the presence of a solvent. It is preferred that a polar solvent be used and it is particularly preferred that a polar protic solvent be used. In particular water, and more preferably alcohols such as, for example, ethanol, propanol, butanol, hexanol or octanol or mixtures of water and alcohols have proven useful as polar protic solvent. The higher alcohols among the alcohols referred to can be primary, secondary or tertiary alcohols. Ethanol is particularly useful as the solvent because the cationic catalyst is very amenable to being recycled and recovered. However, the synthesis can also be carried out without solvent.

The zinc carboxylate prepared with cationic surfactants can have different morphologies as a crystallite or as a virtually amorphous phase. It can, for example, form as thin platelets, similar to zinc carboxylates that are crystallized in water or toluene [Zheng, Y.-Q.; Lin, J.-L.; Zhang, H. L. Zeitschrift für Kristallographie—New Crystal Structures (2000), 215(4), 535-536], though these have several times (3-10×) the surface area. One of the dimensions, in particular, of the crystallites decreases considerably in size and the surface may appear curved or straight. The zinc carboxylate can also crystallize as rods. These rods can be nano-scale, i.e. the longest dimension is in the range from 30 to 1000 nm, the shortest in the range from 5 to 100 nm. It is preferred that these rods are less than 500 nm long and 50 nm wide. These rods have a high catalytic activity and, following a catalytic copolymerization of propylene oxide and carbon dioxide, are still present in the polypropylene carbonate (PPC). Owing to the nano-scale dimensions of the catalyst, the catalyst-containing polypropylene carbonate appears transparent. Further morphologies or mixed phases of platelets or rods of the catalyst can also be obtained with this method.

The zinc dicarboxylates and particularly the zinc glutarates prepared according to the above-mentioned process generally have a BET surface area of 50 to 750 m²/g, and preferably 100 to 500 m²/g, measured according to the method described in the examples (Analysis). After work-up and, in particular, drying, the zinc dicarboxylates and particularly the zinc glutarates prepared according to the abovementioned process have a residual nitrogen content of 0.4 to 5 wt %, preferably 1 to 2 wt %, based on the zinc salt.

### EXAMPLES

1. Catalyst Preparation

### Example 1

3 g of zinc nitrate hexahydrate (10 mmol) and 1.26 g (9.5 mmol) of glutaric acid were dissolved in 150 ml of ethanol in a 300 ml conical flask. 10 g of hexadecylamine were added to the zinc nitrate solution, with stirring, and stirred overnight. After being stirred for about 15 hours, the viscous mass was filtered through a D3 glass frit. The precipitate was washed three times with 50 ml of ethanol and dried at 70° C. in a drying cabinet. The white solid obtained was triturated and weighed (about 6.5 g). Remaining hexadecylamine was removed (about 4 to 6 hours) at 170° C. under an oil-pump vacuum (6×10⁻² bar). The catalyst obtained (100% yield) was once more triturated, and heated at 200° C. for at least 3 hours under reduced pressure (0.1 mbar).

### Example 2

30 g of zinc nitrate hexahydrate and 12.6 g of glutaric acid were dissolved in 1500 ml of ethanol in a 3 l HWS stirred vessel. 100 g of hexadecylamine were added to the zinc nitrate solution with stirring. The mixture was stirred for 12 h at room temperature and the viscous mass was filtered through a D3 glass frit. The precipitate was subsequently washed three times with 500 ml of ethanol each time and dried at 70-100° C. in a drying cabinet. Additionally, the product was dried for 5-10 h under a stream of protective gas (argon or nitrogen) in vacuo.

### Example 3

30 g of zinc nitrate hexahydrate and 12.6 g of glutaric acid were dissolved in 1500 ml of ethanol in a 3 l HWS stirred vessel. 50 g of hexadecylamine were added to the zinc nitrate solution with stirring. The mixture was stirred for 12 h at room temperature and the viscous mass was filtered through a D3 glass frit. The precipitate was subsequently washed three times with 500 ml of ethanol each time and dried at 70-100° C. in a drying cabinet. Additionally, the product was dried for 5-10 h under a stream of protective gas (argon or nitrogen) in vacuo.

### Example 4

1.63 kg of zinc nitrate hexahydrate (5.48 mol), 0.685 kg of glutaric acid (5.18 mol) and 5.43 kg of hexadecylamine (22.5 mol) were dissolved in 81.5 l of ethanol and stirred for 12 hours at room temperature in a 220 l stirred tank. The resulting suspension was transferred to a 130 l filtration unit using a conveying pump. A Teflon filter plate with a pore diameter of 40 pm was used. The precipitate obtained was dried for 80 hours at 60° C. under reduced pressure. 3.13 kg of a solid were obtained. From this solid, about 1.95 kg of hexadecylamine were removed and 1.18 kg of zinc glutarate were obtained in a 10 l steel reactor as nanoscopic catalyst by stirring (close clearance) at a pressure of about 0.5 mbar and a temperature of 160° C.

### Example 5 (Use Of Other Dicarboxylic Acids)

The synthetic procedure of Example 1 was only altered insofar as other dicarboxylic acids (succinic acid, adipic acid, pimelic acid and azelaic acid (nonanedioic acid)) were used in place of glutaric acid. Generally, the zinc dicarboxylates of Example 5 were less active than zinc glutarate in the polypropylene carbonate synthesis.

TABLE 1

| | Activity | Pressure | Temperature | cPC** |
|---|---|---|---|---|
| Catalysts | g PPC/g Zn*h | (bar) PO* | ° C. | (%) |
| Zn succinate | 6.8 | 8 | 60 | 3 |
| Zn adipate | 8.5 | 8 | 60 | 6 |
| Zn pimelate | 11.6 | 8 | 60 | 9 |
| Zn azelate | 5.6 | 8 | 60 | |

*PO = propylene oxide
**cPC = cyclic propylene carbonate

### Examples 6a to 6V-g) (Use Of Other Emulsifiers)

Longer chain and also shorter chain amines were used in place of hexadecylamine in the zinc glutarate synthesis of Example 1. The C₁₀-C₃₀ alkylamines generally showed the highest activities. Furthermore, zinc glutarates prepared with cationic emulsifiers showed higher activities than comparative (“V”) systems prepared with nonionic or anionic emulsifiers (see Table 2).

TABLE 2

| Emulsifiers | | Tempera- | Pressure |
|---|---|---|---|
| used | Activities* | ture° C. | (bar) PO |
| Cationic | | | |
| a) Hexadecylamine | 77 | 60 | 8 |
| b) Octadecylamine | 80 | 60 | 8 |
| c) Dodecylamine | 6.7 | 60 | 8 |
| d) Tetradecylamine | 26 | 60 | 8 |
| e) Triethylamine | 8.7 | 60 | 8 |
| Nonionic | | | |
| V-f) PEG 6000 | 4 | 60 | 8 |
| Anionic | | | |
| V-g) Stearic acid | 0 | 60 | 8 |

*Activity is PPC(g)/Zn(g)*time(h)

### Example 7 (BET Surface Area Of Various Zinc Glutarates)

Example 7 was carried out in the same way as Example 1 except that a different amount-of-substance ratio (molar ratio) of zinc salt/amine (emulsifier) was used. These tests show that zinc glutarates having larger surface areas and a greater number of active sites are obtained using the process according to the invention.

TABLE 3
Catalyst activity and BET surface areas

| | | BET | Activity* |
|---|---|---|---|
| | Method of synthesis | m²/g | g PPC/g Zn*h |
| 1 | Without addition of amine | 19.6 | 10 |
| 2 | Zn salt/amine/solvent | 61.2 | 24 |
| | 1:1.2:500 (platelets) | | |
| 3 | Zn salt/amine/solvent | 314 | 102 (284 |
| | 1:4:250 (rods) | | at 80° C.) |

*Polymerization at 8 bar PO and 60° C.

### Example 7 (Drying Temperature And Catalytic Activity)

Example 7 was carried out in the same way as Example 1 except that different drying temperatures were used. Table 4 shows the drying temperatures and the nitrogen content of zinc glutarates with the respective activity and productivity of the catalyst in 4 hours of PPC synthesis. The highest activity was achieved at the lowest temperature of 140° C. In order to determine the activities, polymerizations were carried out over 4 hours at 60° C. under 20 bar CO₂ pressure with 0.20 g of catalyst and 30 ml of propylene oxide. These examples show how the catalytic activity can be influenced via drying.

TABLE 4

| Drying temperature | Activity | Productivity | Nitrogen content |
|---|---|---|---|
| [° C.] | [g PPC/g Zn* h] | [g PPC/g Zn] | [wt %] |
| 195 | 41 | 164 | 0.4 |
| 180 | 45 | 181 | 0.79 |
| 170 | 65 | 260 | 0.4 |
| 150 | 108 | 431 | 1.12 |
| 140 | 129 | 517 | 1.39 |

2. Preparation Of Polypropylene Carbonate (Determination Of The Activity Of The Catalysts Prepared In The Examples)

a. Polymerization

The propylene carbonate was prepared analogously to WO 03/029325 unless otherwise stated. 2.0 to 4.0 g of zinc glutarate was initially charged into the reactor. A 3.5 l autoclave with mechanical stirrer was used. After the reactor was sealed, it was repeatedly purged with N₂ gas. 620 g of toluene were then added and 6 bar of CO₂ was injected into the reactor at room temperature (23° C.). Subsequently, 310 g of propylene oxide (PO) were injected into the reactor followed by heating to 80° C. Thereafter, sufficient CO2 was injected into the reactor at 80° C. to establish a CO₂ pressure of 40 bar. The reactor was held at 80° C. for 4 h during which no further CO₂ was added. This was followed by cooling down to room temperature.

b. Work-Up

Work-up was carried out according to WO 03/029325A1. The reactor was vented and the reactor contents were poured into 1 l of methanol that had been acidified with 5 ml of conc. hydrochloric acid (37 wt %). A polymer precipitated out and this was filtered off and dried overnight at 60° C. under reduced pressure.

c. Analysis

BET surface area. The nitrogen physisorption measurements were carried out on a Quadrasorb SI instrument from Quantachrome Instruments. The samples were first activated at a degasser station from Quantachrome. The measurements were carried out at 77.35K. The measurement data were analyzed using the program Quadra Win Version 3.0.

The results for the polypropylene carbonates prepared according to procedure a) are set out in Table 5 below.

TABLE 5

| | | PO | g of | Mₙ | % Carbon- |
|---|---|---|---|---|---|
| Zinc | | conver- | Polymer/ | [g/mol], | ate, |
| glutarate | PO: cat. | sion | g Zn | PDI | % cPC |
| WO03/029325 | 88 | 33.2 | 45.3 | 35.000, 14.6 | 94.4, 1.8 |
| WO06/092442 | 88 | 58.6 | 79.6 | 49.000, 11.4 | 96.1, 1.0 |
| Ex. 1 | 88 | 88 | 357 | 47.000, 6.4 | 90.1, 0.8 |

The molar masses were determined by GPC, with THF as solvent and polystyrene as standard; cPC (cyclic propylene carbonate) and carbonate fractions (the remainder to 100 are ether fractions) in the polymer were calculated from ¹H NMR spectra (solvent CDCl₃, 400 MHz); here the middle carbonate methylene group at 1.35 ppm was related to the cPC methylene group at 1.48-1.50 ppm and the ether carbonate and carbonate ether methylene groups at 1.1-1.3 ppm.

Further polymerization results for the zinc glutarate prepared according to the invention (Example 1); this time at 60° C. and with variation of the reaction pressure and the reaction time are detailed in Table 6.

TABLE 6

| | Activity | Time | | | Cat | PO | | | | Mn |
|---|---|---|---|---|---|---|---|---|---|---|
| Cat | g PPC/g Zn*h | (h) | Pressure | T° C. | (g) | (mL) | g PPC/g Zn | cPC | Carbonate | (GPC) |
| Ex. 1 | 77 | 4 | 8 | 60° C. | 0.3 | 50 | 312 | 5% | 82% | 80000 |
| Ex. 1 | 92 | 4 | 21 | 60° C. | 0.2 | 30 | 370 | 4% | 90% | 98000 |
| Ex. 1 | 94 | 4 | 25 | 60° C. | 0.2 | 30 | 380 | 5% | 90% | 118000 |
| Ex. 1 | 86 | 4 | 30 | 60° C. | 0.2 | 30 | 350 | 5% | 91% | 74000 |
| Ex. 1 | 67 | 4 | 40 | 60° C. | 0.2 | 30 | 270 | 4% | 94% | 76000 |
| Ex. 1 | 25 | 50 | 8 | 60° C. | 0.2 | 100 | 1000 | 19% | 81% | 88000 |

The results of Tables 3 and 4 show that the zinc glutarate prepared according to the invention is about two to three times as active as the zinc glutarate prepared according to WO03/029325 or WO06/092442. As a result, fewer washing cycles are required to achieve a residual content of 10 ppm of zinc. Furthermore, about 50% less acid, such as citric acid for example, is required in the work-up of the polymer solutions. Also, less by-product such as cyclic carbonate is formed. Lastly, a polypropylene carbonate is formed having a narrower molecular weight distribution than with conventional processes (PDI of 6 compared to PDI of 14 and 11, respectively), and a higher propylene oxide (PO) conversion is achieved than with conventional processes (88% PO conversion rather than 59% and 33%, respectively).

1-13. (canceled)

14. A process for preparing a zinc dicarboxylate from a zinc compound and a C₄-C₁₀ dicarboxylic acid in the presence of a primary C₁₀-C₃₀ alkylamine and a solvent.

15. The process according to claim 14, wherein the alkylamine is n-hexadecylamine.

16. The process according to claim 14, wherein glutaric is used as the C₄-C₁₀ dicarboxylic acid.

17. The process according to claim 14, wherein the solvent is an alcohol.

18. The process according to claim 14, wherein the alkylamine is used in a molar ratio of 4:1 to 1:1, based on the zinc compound.

19. The process according to claim 14, wherein the zinc dicarboxylate formed is dried at 130 to 170° C.

20. A process for preparing polyalkylene carbonates by polymerizing carbon dioxide with at least one epoxide selected from ethylene oxide, propylene oxide, butene oxide, cyclopentene oxide, and cyclohexene oxide, in the presence of the zinc dicarboxylate obtained by the process according to claim 14.

21. The process according to claim 20, wherein the polyalkylene carbonate is a propylene carbonate.
